(19) United States
(12) Patent Application Publication
(10) Pub. No.: US 2019/0039231 A1
(43) Pub. Date: Feb. 7, 2019

(54) Fingertip Ratchet

(71) Applicant: Vahagn Sargsyan, Boise, ID (US)

(72) Inventor: Vahagn Sargsyan, Boise, ID (US)

(21) Appl. No.: 15/668,205

(22) Filed: Aug. 3, 2017

(51) Int. Cl. B25G 1/10; B25B 15/04

(52) U.S. Cl. CPC B25G 1/107; B25B 15/04

(57) ABSTRACT

The unit is a thimble with screw or wrench head on top of it, see FIG. 1 for illustration. The Fingertip Ratchet consists of a finger-cap with a ratchet, at the end of which a desired screw head (cross or flat or nut driver or Allen key, etc.) can be placed. The finger ratchet screwdriver gives benefits of tighter space work access, easier control and handle. Ideal for delicate jobs like for watch makers, jewelers, etc.

The present invention relates to a finger ratchet screwdriver. The principal object of the invention is to provide a solution to operate a screwdriver by using only one finger. If before one needed at least two fingers to hold and operate a screwdriver, with this invention just a single finger will do the job.

In order that the invention may be readily carried into effect, it will now be described with reference to the accompanying drawings, wherein:

FIG. 1 is a side view, showing a finger 4 positioned inside the finger-cap 1. The finger-cap 1, fits tightly on the finger. You also see the ratchet unit 2, sitting on the finger-cap, and a cross screwdriver head 3, is inserted in the ratchet unit hole. Note that besides the ratchet unit 2, there is also a possibility to use a motor drive unit, or Velcro fit adjustable band, instead;

FIG. 2 is a side view, just as in FIG. 1, but here the components are apart from each other. There are three main units: the finger-cap 1, the ratchet unit 2, and the screw head 3. The figure also shows the opening 5, on the other side of the ratchet unit, which is for fixing a desired screw head type. Note, that besides the screws one can also insert an Allen-wrench, or a nut driver, or other such tools.

The finger ratchet screwdriver gives the benefit of tighter space work access, easier control and handling. Prior to this invention one had to use at least two fingers to hold and use a screwdriver, now the task can be done with just one finger. It could be ideal for a watch maker, eye-glasses repair, jewelers, etc.

### BRIEF DESCRIPTION OF THE DRAWINGS

FIG. 1: Finger screwdriver/wrench concept illustration. It shows how the tool looks like when placed on a finger ready to be used.

FIG. 2: Finger-cap, ratchet unit, and the screw head with some distance. It shows all main parts of the tool in distance from each other.

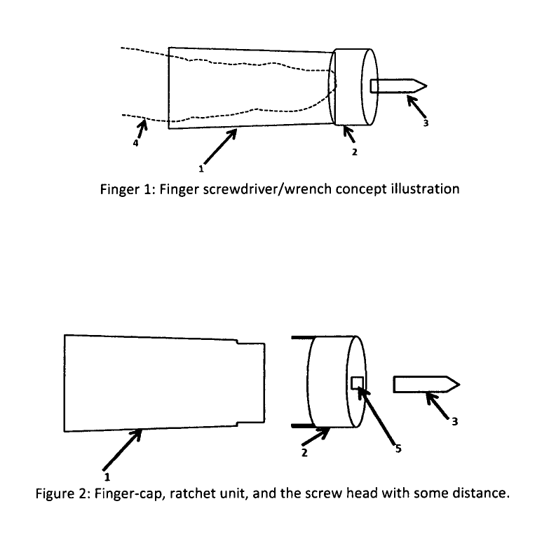

1. A fingertip ratchet for rotation of tool bits, comprising:
a generally cylindrical ratchet body sized to allow insertion of a user's finger, said ratchet body having a sidewall surrounding a body interior, and a first end and a second end, with said second end being open for insertion of a user's finger;
a ratchet head attached to said first end, with said ratchet head comprising a rotatable tool insert for removable insertion of a selected tool; and
with said rotatable tool movable in a selected direction when the ratchet body is rotated by a finger.

2. Ratchet head may be removable from the ratchet body.

3. Ratchet head may be attachable to the ratchet body by extending posts or prongs.

4. The tool insert may be flush with the top of the ratchet head, or may extend above the ratchet body.

5. The tools may be selected from screw drivers bits, nut driver bits, twist drills, alien wrenches, blades, polishing bits, files,

6. A switch may be present to reverse the direction of rotation of the driver.

7. A motor may be present to provide powered rotation to the tool insert.
